(19) United States
(12) Patent Application Publication
(10) Pub. No.: US 2018/0010661 A1
(43) Pub. Date: Jan. 11, 2018

(54) FRICTION MATERIAL COMPOSITION, FRICTION MATERIAL USING SAID FRICTION MATERIAL COMPOSITION, AND FRICTION MEMBER

(71) Applicant: JAPAN BRAKE INDUSTRIAL CO., LTD., Hachioji-shi, Tokyo (JP)

(72) Inventors: Mitsuo UNNO, Hachioji-shi (JP); Masamichi MITSUMOTO, Koganei-shi (JP)

(73) Assignee: JAPAN BRAKE INDUSTRIAL CO., LTD., Hachioji-shi, Tokyo (JP)

(21) Appl. No.: 15/539,216

(22) PCT Filed: Nov. 16, 2015
(86) PCT No.: PCT/JP2015/082120

§ 371 Date: Jun. 23, 2017

(30) Foreign Application Priority Data
Dec. 24, 2014 (JP) 2014-260993

(51) Int. Cl. F16D 69/02; F16D 69/00; F16D 65/12; F16D 65/04

(52) U.S. Cl. CPC F16D 69/028; F16D 69/026; F16D 2200/0065; F16D 2200/0052; F16D 2200/0034; F16D 2200/003; F16D 65/04; F16D 2200/0013; F16D 2069/002; F16D 65/12; F16D 2200/0082; F16D 2200/0021

(57) ABSTRACT

A friction material composition that enables a friction material, which contains no copper or contains not more than 0.5 mass % of copper, to maintain sufficient friction coefficient in fade conditions at high speed such that brake temperature rises abnormally by repeated rapid braking at deceleration of 0.8 G from a vehicle speed of 200 km/h, is provided. A friction material obtained by molding the friction material composition is also provided. The friction material composition contains a binder, an organic filler, an inorganic filler, and a fibrous base material, and the friction material composition contains no copper as an element or contains not more than 0.5 mass % of copper, and also contains 2 to 5 mass % of steel fibers that have fiber lengths of 800 μm or more.

### TECHNICAL FIELD

The present invention relates to a friction material composition that is suitable for a friction material of a disc brake pad or other part, which is used for braking an automobile or the like, and also relates to a friction material using the friction material composition.

### BACKGROUND ART

Automobiles and other vehicles use friction materials in disc brake pads, brake linings, and other parts to brake. The friction material rubs against a mating material such as of a disc rotor or a brake drum and thereby performs braking. Thus, the friction material is required to have a preferable friction coefficient, high abrasion resistance exhibiting a long service life, high strength, sound vibration performance for decreasing brake noise and low frequency noise, and other preferable characteristics. The friction coefficient is required to be constant regardless of vehicle speed, deceleration, and brake temperature. A recent requirement regarding the friction material is a reduced decrease in friction coefficient or reduced deterioration in fade characteristics at high speed, even in severe braking conditions, such that brake temperature rises abnormally by continuous braking at high deceleration of at least 0.8 G from a high vehicle speed of 200 km/h or higher.

On the other hand, copper contained in a friction material tends to be scattered as powder from wear of a brake and can cause pollution of rivers, lakes, oceans, and other natural environments, and thus, restriction of the use of copper has been increasing in recent years. Copper in the form of fibers or in the form of powder is contained in a friction material and is effective to maintain high friction coefficient or superior fade resistance under braking conditions at high temperatures and to improve abrasion resistance at high temperatures. Thus, the above fade characteristics at high temperatures greatly deteriorate in a friction material that contains no copper.

In response to such a trend toward restriction of the use of copper, the following friction materials that contain no copper but exhibit improved frictional characteristics at high temperatures are being developed. One is a friction material containing at least one kind of titanic acid compound and biodegradable inorganic fibers, as disclosed in Patent Document 1. Yet another one is a friction material containing binder, organic fibers, metal sulfide-based lubricant, carbonaceous-based lubricant, titanate, mild or hard abrasive, organic friction modifier, and pH modifier, as disclosed in Patent Document 2.

Patent Document 1 is Japanese Unexamined Patent Application Publication No. 2013-076058. Patent Document 2 is Japanese Unexamined Patent Application Publication No. 2014-156589.

### DISCLOSURE OF THE INVENTION

### Problems Solved by the Invention

The friction materials, which are disclosed in Patent Documents 1 and 2 and contain no copper, have unsatisfactory fade characteristics at high vehicle speed of 200 km/h or higher. The present invention has been completed in view of these circumstances, and an object of the present invention is to provide a technique for maintaining a sufficient degree of friction coefficient even in fade conditions at high speed such that brake temperature rises abnormally by repeated braking at deceleration of 0.8 G from a high vehicle speed of 200 km/h. In particular, an object of the present invention is to provide a friction material composition that enables a friction material to exhibit superior fade characteristics at high speed even though the friction material contains no copper or contains not more than 0.5 mass % of copper.

### Means for Solving the Problems

The inventors of the present invention found that addition of steel fibers with long fiber lengths at a specific amount to a friction material composition that does not contain environmentally harmful copper, enables the maintenance of high friction coefficient in fade conditions at high speed and also to provide superior abrasion resistance at low temperatures. A surface of a friction material can be incinerated at high temperatures while receiving shearing force due to friction in a condition such as fade conditions at high speed. In such a severe friction condition, steel fibers with long fiber lengths greatly reinforce an incinerated layer and lead to maintaining of high friction coefficient. However, a large amount of the steel fibers with long fiber lengths tend to facilitate adhesive wear relative to a friction mating material and deteriorate abrasion resistance at low temperatures. Thus, the steel fibers with long fiber lengths in a specific appropriate amount is added to obtain high friction coefficient in fade conditions at high speed as well as preferable abrasion resistance at low temperatures.

The friction material composition of the present invention is based on these findings and contains a binder, an organic filler, an inorganic filler, and a fibrous base material. The friction material composition contains no copper as an element or contains not more than 0.5 mass % of copper and 2 to 5 mass of steel fibers having fiber lengths of 800 μm or more.

In the friction material composition of the present invention, the steel fibers preferably have a curled shape and preferably have an average fiber diameter of 60 μm or more.

The friction material of the present invention is obtained by molding the friction material composition described above, and the friction member of the present invention is formed by using the friction material, which is molded by using the friction material composition, and a back metal.

### Effects of the Invention

The present invention provides a friction material composition that does not especially contain copper (which has a high environmental load) or contains copper in such small amount as to be not more than 0.5 mass % even when it does contain copper, but that still provides high friction coefficient in fade conditions at high speed and superior abrasion resistance at low temperatures when used in a friction material such as of an automobile disc brake pad. The present invention also provides a friction material and a friction member, each of which uses the friction material composition.

### BEST MODE FOR CARRYING OUT THE INVENTION

Hereinafter, a friction material composition, and a friction material and a friction member, each of which uses the friction material composition, of the present invention, will be described in detail. The friction material composition of the present invention does not contain asbestos and is a so-called “non-asbestos friction material composition”.

<Friction Material Composition>

The friction material composition of this embodiment contains no copper or contains copper in such small amount as to be not more than 0.5 mass % even when containing copper. That is, environmentally harmful copper and copper alloys are substantially not contained, and the amount of copper element is not more than 0.5 mass %, preferably, 0 mass %. Thus, even when friction powder is generated in braking, the friction powder will not cause pollution of rivers, lakes, and oceans.

Steel Fibers

The friction material composition of the present invention contains 2 to 5 mass % of steel fibers that have fiber lengths of 800 μm or more. Steel fibers with long fiber lengths greatly reinforce an incinerated layer and lead to maintaining of high friction coefficient, and thus, the lengths of the steel fibers are set at 800 μm or more. The fiber lengths of the steel fibers, which have fiber lengths of 800 μm or more, are preferably 1000 μm or less because the effect for reinforcing an incinerated layer is not further increased. The fiber lengths of the steel fibers are more preferably 300 to 800 μm.

The type of steel fibers includes a straight type and a curled shape type. The straight fibers may be obtained by chatter machining. The curled fibers may be obtained by cutting long fibers. The straight fibers have a straight shape, whereas the curled fibers have curved portions that include simple circular shaped portions, winding portions, helical portions, and spiral portions. The steel fibers that have fiber lengths of 800 μm or more and that are either one of the straight type and the curled shape type dissipate frictional heat at a friction interface and thereby reduce the uneven increase in temperature as well as moderately cleans organic decomposed substances, which are generated on the friction interface. Thus, each type of the steel fibers reduce variation in the brake torque, which occurs in braking, thereby making the brake vibration unlikely to occur and decreasing the brake vibration. However, the curled fibers are preferable because less of the curled fibers come off from the friction material at the friction interface, and frictional characteristics in fade conditions at high speed are more effectively maintained, compared with the straight fibers. Moreover, curled fibers that contain portions having curvature radius of 100 μm or less are more preferable because they more strongly adhere to the friction material and are made less likely to come off from the friction material at the friction interface. Regarding the curled shape steel fibers, commercially available fibers, for example, cut steel wool produced by Nippon Steel Wool Co., Ltd., may be used.

The average fiber diameter of the steel fibers in the friction material composition is preferably 60 μm or more from the viewpoint of maintaining high friction coefficient in fade conditions at high speed. The average fiber diameter of the steel fibers is more preferably 100 μm or more because the effect for reinforcing an incinerated layer increases as the average fiber diameter of the steel fibers increases. On the other hand, when steel fibers have excessively large diameters, the amount of the steel fibers is decreased, whereby the effect for reinforcing an incinerated layer is undesirably reduced. Thus, the average fiber diameter of the steel fibers is preferably 500 μm or less. The average fiber diameter of the steel fibers is more preferably 100 to 300 μm.

The fiber lengths and the average fiber diameter of the steel fibers can be measured by using a microscope or other equipment. The fiber lengths and the average fiber diameter of the steel fibers contained in the friction material can be measured by observing Fe component in iron fibers by an electron beam microanalyzer such as an EPMA. The iron fibers exist in ashes that are obtained by heating the friction material at 800° C. in an air stream. Alternatively, the ashes may be magnetically separated into the iron fibers and other components, and the iron fibers may be observed by a microscope or an electron beam microanalyzer such as an EPMA.

The amount of the steel fibers is set to be in the range of 2 to 5 mass %, whereby high friction coefficient in fade conditions at high speed is maintained, and preferable abrasion resistance at low temperatures is obtained. If the amount of the steel fibers is less than 2 mass %, the effect for reinforcing a surface of a friction material in fade conditions at high speed is not sufficiently obtained. If the amount of the steel fibers exceeds 5 mass %, adhesive wear is increased between the steel fibers and cast iron of a mating material, thereby deteriorating abrasion resistance at low temperatures. The amount of the steel fibers contained in the friction material composition or the friction material can be measured by, for example, quantitative analysis of Fe component in any cross section of the friction material by an electron beam microanalyzer such as an EPMA. In this case, when the friction material contains Fe component that comes from only the steel fibers, the analysis value of the quantitative analysis can be just used as the amount of the steel fibers. Otherwise, when the friction material also contains Fe component that comes from materials other than the steel fibers, such as iron powder, a total amount of Fe component, which comes from the steel fibers and the other materials in a visual field of any cross section that is observed, is measured as the analysis value of the quantitative analysis. In such a case, an area ratio of Fe component of the steel fibers and the other materials in the observation visual field is measured, and the product of a ratio of the area of the steel fibers to the total area of Fe component of the steel fibers and the other materials, and the total amount of Fe component that is quantitatively analyzed, is calculated. Thus, the amount of the steel fibers is simply calculated.

Binder

The binder integrally binds an organic filler, an inorganic filler, a fibrous base material, and other components that are contained in the friction material composition and strengthens the friction material composition. The binder that is contained in the friction material composition of the present invention is not limited to a specific agent, and a thermosetting resin, which is normally used as a binder of a friction material, can be used.

The thermosetting resin includes, for example, a phenol resin, each kind of elastomer dispersed phenol resins such as an acrylic elastomer dispersed phenol resin and a silicone elastomer dispersed phenol resin, and each kind of modified phenol resins such as an acrylic-modified phenol resin, a silicone-modified phenol resin, a cashew-modified phenol resin, an epoxy-modified phenol resin, and an alkyl benzene-modified phenol resin. One of these resins can be used alone or a combination of two or more of these resins can be used. In particular, it is preferable to use the phenol resin, the acrylic-modified phenol resin, the silicone-modified phenol resin, or the alkyl benzene-modified phenol resin because they provide superior heat resistance, superior formability, and preferable friction coefficient.

The amount of the binder in the friction material composition of the present invention is preferably 5 to 20 mass %, more preferably 5 to 10 mass %. The amount of the binder is set to be in the range of 5 to 20 mass %, whereby decrease in the strength of the friction material is more reliably prevented, and a porosity of the friction material is decreased, resulting in more reliably preventing deterioration of sound vibration performance due to increase in an elastic modulus, which may cause squeaking.

Organic Filler

The organic filler is contained as a friction modifier to improve the sound vibration performance, the abrasion resistance, and other characteristics of the friction material. The organic filler that is contained in the friction material composition of the present invention may be any material that can exhibit the above functions. Cashew dust and rubber components, which are normally used as organic fillers, may be used.

The cashew dust can be that which is obtained by crushing a cured material of cashew nut shell oil and which are normally used in a friction material.

The rubber component includes, for example, tire rubber, acrylic rubber, isoprene rubber, nitrile-butadiene rubber (NBR), styrene-butadiene rubber (SBR), chlorinated butyl rubber, butyl rubber, and silicone rubber. One of these types of rubber can be used alone or a combination of two or more of these types of rubber can be used.

The amount of the organic filler in the friction material composition of the present invention is preferably 1 to 20 mass %, more preferably 1 to 10 mass %, and even more preferably 3 to 8 mass %. The amount of the organic filler is set to be in the range of 1 to 20 mass %, whereby increase in the elastic modulus of the friction material and deterioration of the sound vibration performance, which may cause squeaking, are avoided, and decrease in the heat resistance and decrease in the strength due to heat history are also avoided.

Inorganic Filler

The inorganic filler is contained as a friction modifier to avoid decrease in the heat resistance of the friction material and to improve the abrasion resistance as well as the friction coefficient. Any inorganic filler that is normally used in a friction material can be used in the friction material composition of the present invention.

The inorganic filler is, for example, tin sulfide, bismuth sulfide, molybdenum disulfide, iron sulfide, antimony trisulfide, zinc sulfide, calcium hydroxide, calcium oxide, sodium carbonate, barium sulfate, coke, mica, vermiculite, calcium sulfate, talc, clay, zeolite, mullite, chromite, titanium oxide, magnesium oxide, silica, dolomite, calcium carbonate, magnesium carbonate, titanate having a granular shape or a plate shape, zirconium silicate, y alumina, manganese dioxide, zinc oxide, triiron tetroxide, cerium oxide, zirconia, or graphite. One of these substances can be used alone or a combination of two or more of these substances can be used. The titanate having the granular shape or the plate shape may be potassium hexatitanate, potassium octatitanate, lithium potassium titanate, magnesium potassium titanate, sodium titanate, or other substance.

The amount of the inorganic filler in the friction material composition of the present invention is preferably 30 to 80 mass %, more preferably 40 to 70 mass %, and even more preferably 50 to 60 mass %. The amount of the inorganic filler is preferably set to be in the range of 30 to 80 mass % because decrease in the heat resistance is avoided and the balance of the amounts of the inorganic filler and the other components in the friction material is favorable.

Fibrous Base Material

The fibrous base material exhibits a reinforcing effect in the friction material. The friction material composition of the present invention may use inorganic fibers, metal fibers, organic fibers, carbon-based fibers, or other fibers, which are normally used as a fibrous base material. One of these fibers can be used alone or a combination of two or more of these fibers can be used.

The inorganic fibers may be ceramic fibers, biodegradable ceramic fibers, mineral fibers, glass fibers, silicate fibers, or other fibers, and one of these fibers can be used alone or a combination of two or more of these fibers can be used. Biodegradable mineral fibers containing any combination of SiO₂, Al₂O₃, CaO, MgO, FeO, Na₂O, and other substances, are preferable among these inorganic fibers. Specifically, commercial available fibers such as of the Roxul series produced by Lapinus Fibers B.V. may be used.

The metal fibers may be any fibers that are normally used in friction materials, and for example, fibers made primarily of a metal or an alloy such as of aluminum, iron, cast iron, zinc, tin, titanium, nickel, magnesium, silicon, copper, or brass can be used. The metal or the alloy of each such material may also be contained in the form of powder instead of in the form of fibers. However, it is preferable not to contain copper and alloys containing copper from the viewpoint of adverse environmental impact.

The organic fibers may be aramid fibers, cellulose fibers, acrylic fibers, phenol resin fibers, or other fibers, and one of these fibers can be used alone or a combination of two or more of these fibers can be used.

The carbon-based fibers may be flameproof fibers, pitch-based carbon fibers, PAN-based carbon fibers, activated carbon fibers, or other fibers, and one of these fibers can be used alone or a combination of two or more of these fibers can be used.

The amount of the fibrous base material in the friction material composition of the present invention is preferably 5 to 40 mass %, more preferably 5 to 20 mass %, and even more preferably 5 to 15 mass %. The amount of the fibrous base material is set to be in the range of 5 to 40 mass %, whereby a porosity suitable for a friction material is obtained, thereby preventing squeaking, and an appropriate material strength and high abrasion resistance are obtained as well as the formability being improved.

<Friction Material>

The friction material of this embodiment can be produced by molding the friction material composition of the present invention by a commonly used method, which is preferably hot press molding. Specifically, for example, the friction material composition of the present invention may be uniformly mixed by a mixer, such as a Loedige mixer (“Loedige” is a registered trademark), a pressurizing kneader, or an Eirich mixer (“Eirich” is a registered trademark). The mixture may be premolded in a mold, and the premold may be further molded at a molding temperature of 130 to 160° C. and at a molding pressure of 20 to 50 MPa for a molding time of 2 to 10 minutes. The molded body may be heat treated at a temperature of 150 to 250° C. for 2 to 10 hours. Thus, the friction material is produced. The friction material may be produced by further performing coating, a scorch treatment, or a polishing treatment as necessary.

<Friction Member>

The friction member of this embodiment is formed by using the friction material of this embodiment as a friction material to be used as a friction surface. The friction member has, for example, one of the following structures.

(1) A structure formed only of the friction material
(2) A structure formed of a back metal and a friction material, which is mounted on the back metal and is made of the friction material composition of the present invention and which is to be used as a friction surface.
(3) A structure of interposing both a primer layer, which modifies a surface of the back metal to improve an effect for adhering the back metal, and an adhesive layer, which adheres the back metal and the friction material, between the back metal and the friction material of the structure (2)

A back metal is normally used in a friction member to improve the mechanical strength of the friction member. The material of the back metal may be metal, fiber reinforced plastic, or of another type, and specifically, the material may be iron, stainless steel, inorganic fiber-reinforced plastic, carbon fiber-reinforced plastic, or of another type. The primer layer and the adhesive layer may be those normally used in a friction member, such as a brake shoe.

The friction material composition of this embodiment contains no copper, which has a high environmental load, but enables the reliable maintenance of high friction coefficient in fade conditions at high speed. Thus, the friction material composition of this embodiment is effectively used as a top finishing material of, for example, a disc brake pad or a brake lining for automobiles and other vehicles. The friction material composition of this embodiment can also be used by being molded into an underlying material of a friction member. The top finishing material is a friction material to be used as a friction surface of a friction member. The underlying material is a layer that is interposed between a friction material, which is to be used as a friction surface of a friction member, and a back metal and that is used to improve shear strength in the proximity to adhered portions of the friction material and the back metal, crack resistance, and other characteristics.

### Examples

Hereinafter, the friction material composition, the friction material, and the friction member of the present invention will be described in more detail by using examples and comparative examples, but the present invention is not limited by these examples.

### Examples 1 and 2 and Comparative Examples 1 to 3

Preparation of Disc Brake Pads

Materials were mixed together in accordance with the mixing ratios shown in Table 1, and friction material compositions of examples 1 and 2 and comparative examples 1 to 3 were obtained. The mixing ratios shown in Table 1 are in mass %. Steel fibers used in the examples and the comparative examples are “3L-80” produced by Sinoma Co. and have a curled shape, fiber lengths of 900 to 5500 μm, and an average fiber diameter of 106 μm. The fiber lengths were measured by observing the fiber lengths of 100 fibers by a microscope produced by Keyence Corporation. The average fiber diameter was obtained by averaging the fiber diameters of 50 fibers that were observed by the microscope produced by Keyence Corporation.

Each of the friction material compositions was mixed by a Loedige mixer (produced by Matsubo Corporation, product name: Loedige mixer M20), and the mixtures were premolded by a molding press produced by Oji Machine Co., Ltd. The premolds were hot press molded at a molding temperature of 140 to 160° C. and at a molding pressure of 30 MPa for a molding time of 5 minutes by a molding press produced by Sanki Seiko Co., Ltd. in conjunction with corresponding iron back metals produced by Hitachi Automotive Systems, Ltd. The molded bodies were heat treated at 200° C. for 4.5 hours, polished by a rotary polisher, and then scorch treated at 500° C., whereby disc brake pads of the examples 1 and 2 and the practical examples 1 to 3 were obtained. The prepared disc brake pad of each of the examples and the comparative examples has a back metal with a thickness of 6 mm, a friction material with a thickness of 11 mm, and a friction material projected area of 52 cm².

Evaluation of Fade Characteristics at High Speed

An evaluation test for fade characteristics at high speed was performed on the disc brake pad of each of the examples 1 and 2 and the comparative examples 1 to 3, which were prepared in the manner described above, by using a brake dynamometer. The test was performed by using an ordinary colette caliper of the pin slide type and a ventilated disc rotor (produced by Kiriu Corporation, Material: FC190) and by applying a moment of inertia, which was generated by “Skyline V35” manufactured by Nissan Motor Co., Ltd. First, lining bedding was performed in accordance with JASO C427 in the following condition: initial speed of 50 km/h, final speed of 0 km/h, deceleration of 0.3 G, brake temperature before braking of 100° C., and braking 200 times. Thereafter, fade test at high speed was performed in the following condition: initial speed of 200 km/h, final speed of 80 km/h, deceleration of 0.8 G, brake temperature before first braking of 100° C., braking 10 times with an interval of 60 seconds, whereby the minimum value of friction coefficient, that is, the minimum value of an average of friction coefficient during one braking was measured.

Evaluation of Abrasion Resistance at Low Temperature

Abrasion resistance was measured in accordance with JASO C427 specified by the Society of Automotive Engineers of Japan, Inc. A wear amount of the friction material corresponding to braking 1,000 times was evaluated at a braking temperature of 100° C., a vehicle speed of 50 km/h, and a deceleration of 0.3 G as the abrasion resistance at a low temperature.

These tests were performed by using a dynamometer at an inertia of 7 kgf·m·sec². Additionally, these tests were performed by also using the ventilated disc rotor (produced by Kiriu Corporation, Material: FC190) and the ordinary colette caliper of the pin slide type.

TABLE 1

| | | | | Comparative | | |
|---|---|---|---|---|---|---|
| | | Example | | example | | |
| | | 1 | 2 | 1 | 2 | 3 |
| Steel | “3L-80” | 2.5 | 4.5 | 0 | 6 | 0 |
| fibers | Curled shape, fiber lengths | | | | | |
| | of 900~5500 μ m, | | | | | |
| | average fiber | | | | | |
| | diameter of 106 μ m | | | | | |
| Inorganic | Barium sulfate | 22.5 | 20.5 | 25 | 19 | 15 |
| filler | Potassium titanate | 18 | 18 | 18 | 18 | 18 |
| | in a granular shape | | | | | |
| | (“terracess TF-SS”, | | | | | |
| | produced by Otsuka | | | | | |
| | Chemical Co., Ltd.) | | | | | |
| | Zirconia (“BR-QZ”, | 15 | 15 | 15 | 15 | 15 |
| | produced by Daiichi | | | | | |
| | Kigenso Kagaku | | | | | |
| | Kogyo Co., Ltd.) | | | | | |
| | Mica | 5 | 5 | 5 | 5 | 5 |
| | Graphite (“T150”, | 5 | 5 | 5 | 5 | 5 |
| | produced by | | | | | |
| | TIMCAL Ltd.) | | | | | |
| | Calcium hydroxide | 5 | 5 | 5 | 5 | 5 |
| Organic | Cashew dust | 4 | 4 | 4 | 4 | 4 |
| filler | Tire rubber powder | 5 | 5 | 5 | 5 | 5 |
| Binder | Phenol resin | 8 | 8 | 8 | 8 | 8 |
| Fibrous | Aramid fibers | 5 | 5 | 5 | 5 | 5 |
| base | Mineral fibers | 5 | 5 | 5 | 5 | 5 |
| material | Copper fibers | 0 | 0 | 0 | 0 | 10 |

| | | | | | |
|---|---|---|---|---|---|
| Fade characteristics at high speed | 0.21 | 0.22 | 0.12 | 0.20 | 0.20 |
| Minimum value of friction coefficient | | | | | |
| Abrasion resistance at low temperature/ | 0.09 | 0.09 | 0.11 | 0.20 | 0.10 |
| wear amount at 100° C. (mm) | | | | | |

The examples 1 and 2 contained no copper but contained the steel fibers having fiber lengths of 800 μm or more at 2 to 5 mass %, and the fade characteristics at high speed of each of the examples 1 and 2 were equivalent to or superior to those of the comparative example 3, which contained copper. Also, the fade characteristics at high speed of each of the examples 1 and 2 were superior to the comparative example 1, which did not contain the steel fibers having fiber lengths of 800 μm or more. Moreover, the abrasion amount at low temperature of each of the examples 1 and 2 was smaller than that of the comparative example 2, which contained the steel fibers having fiber lengths of 800 μm or more at greater than 5 mass %. Accordingly, it is clear that the examples 1 and 2, which contained the steel fibers having fiber lengths of 800 μm or more at 2 to 5 mass %, were satisfactory because superior fade characteristics at high speed and superior abrasion resistance at low temperature were obtained even though they did not contain copper.

### INDUSTRIAL APPLICABILITY

The friction material composition of the present invention does not especially contain copper, which has a high environmental load, but provides high friction coefficient in fade conditions at high speed and superior abrasion resistance at low temperatures, compared with a conventional composition. Accordingly, the friction material composition of the present invention may be suitably used in a friction material and a friction member of an automobile brake pad or other part.

1. A friction material composition containing a binder, an organic filler, an inorganic filler, and a fibrous base material, and the friction material composition containing no copper as an element or containing not more than 0.5 mass % of copper, and containing 2 to 5 mass % of steel fibers that have fiber lengths of 800 μm or more.

2. The friction material composition according to claim 1, wherein the steel fibers have a curled shape.

3. The friction material composition according to claim 1, wherein the steel fibers have an average fiber diameter of 60 μm or more.

4. A friction material obtained by molding the friction material composition recited in claim 1.

5. A friction member formed by using the friction material, which is molded by using the friction material composition recited in claim 1, and a back metal.
